(19) United States
(12) Patent Application Publication
(10) Pub. No.: US 2006/0143079 A1
(43) Pub. Date: Jun. 29, 2006

(54) Cross-channel customer matching

(76) Inventors: Jayanta Basak, New Delhi (IN); Sunil Goyal, DLF City (IN)

Correspondence Address: FREDERICK W. GIBB, III;GIBB INTELLECTUAL PROPERTY LAW FIRM, LLC, 2568-A RIVA ROAD, SUITE 304, ANNAPOLIS, MD, 21401, US

(21) Appl. No.: 11/025,308

(22) Filed: Dec. 29, 2004

(51) Int. Cl. G06Q 30/00; G07G 1/00

(52) U.S. Cl. 705/14; 705/10

(57) ABSTRACT

A system and method for conducting cross-channel customer identification comprises accessing, for a selected customer and a selected channel, a customer profile that records values for a plurality of customer profile attributes that are independent of the selected channel; comparing the accessed customer profile with a plurality of corresponding customer profiles for one or more channels other than the selected channel; and identifying one or more compared customer profiles as a likely match for the computed customer profile.

### FIELD OF THE INVENTION

The present invention relates to cross-channel customer matching.

### BACKGROUND

Many merchants offer products and services via multiple “channels”(for example, retail stores, direct mail catalogs, online retail sites, mobile phones, and so on) to allow broader reach and customer convenience. One issue associated with multi-channel retailing is cross-channel customer identification, which relates to identifying behaviorally similar customers or customer segments across channels.

To understand customers, retailers track and analyze how people shop and pay, how they behave over time, and how they react to different offers and prices. Using these patterns, retailers can identify and set their priorities for objectives such as increasing sales, profits, and wallet share. An integrated behavioral profile of a customer shopping across multiple channels is desirable for making decisions relating to offering coupons, discounts, promotions, and so on.

One approach to determining behavioral profiles is to impose the same identity (for example, a customer-id) on a customer using different channels, to generate an integrated view of the customer across multiple channels. Establishing the same identity may not, however, be possible for any number of several reasons. For example, a customer may unintentionally register on different channels with different identities, or have intentionally registered with different identities to protect her privacy. In some cases, a customer may not be aware of the fact that all these channels in question belong to the same retailer. This impression may be given in many cases as a merchant's multiple sales channels may operate with relative independence. Profitability may be improved, however, by integrating the operations of these multiple channels.

Without establishing the existence and the identity of the customer across the channels, generating an integrated profile of the customer is not feasible. Furthermore to deliver sales and profit increases, a retailer may want to define an actionable customer segment and target this segment with the same promotions on a channel that were found effective (for example, in delivering sales and profit increases) on another channel with a similar customer segment. Establishing similar customer segments across channels, if not identifying individual customers, is thus particularly desirable.

### SUMMARY

Cross-channel customer matching involves steps of extracting channel-independent profile attribute information from customer behavior in different channels, and matching the channel-independent profile information across channels. Subsequently, particular customers, or customer-segments, can be mapped across channels.

Certain behavioral aspects which are independent of the channel characteristics are first identified. These channel-independent channel attributes are those that do not substantially vary across channels, and can consequently be reasonably compared across channels. For example, a “frequency of visit” or a “frequency of purchase” for a customer in some channel may highly depend on the channel itself. For example, one may wish to view the web channel often, but may like to purchase in the store.

Certain behavioral characteristics of a customer may however remain essentially unaltered across channels. A customer may be loyal to some brand of a product and she exhibits loyalty across channels. Some channel-independent profile attributes of a customer are described herein, as well as techniques for computing such attributes. Such channel-independent profile attributes form profiles of customers in different channels for statistical matching.

### DESCRIPTION OF DRAWINGS

FIG. 1 is a schematic representation of obtaining a channel independent customer profile.

FIG. 2 is a schematic representation of matching customers across selected channels.

FIGS. 3A, 3B and 3C jointly form a flow chart of steps involved in creating and matching customer profiles.

FIG. 4 is a schematic representation of a computer system suitable for performing the techniques described herein.

FIG. 5 is a table of example attributes of a sample customer profile.

FIGS. 6A and 6B are tables involved in an example data structure that can be used for storing a customer profile.

### DETAILED DESCRIPTION

Profiling customer behavior is increasingly important for applications such as targeted promotion delivery. A customer profile is created from a large amount of customer transactional activity to extract patterns. Customer profiles are incrementally created by refining (by updating) the current profile with newly available data at regular intervals.

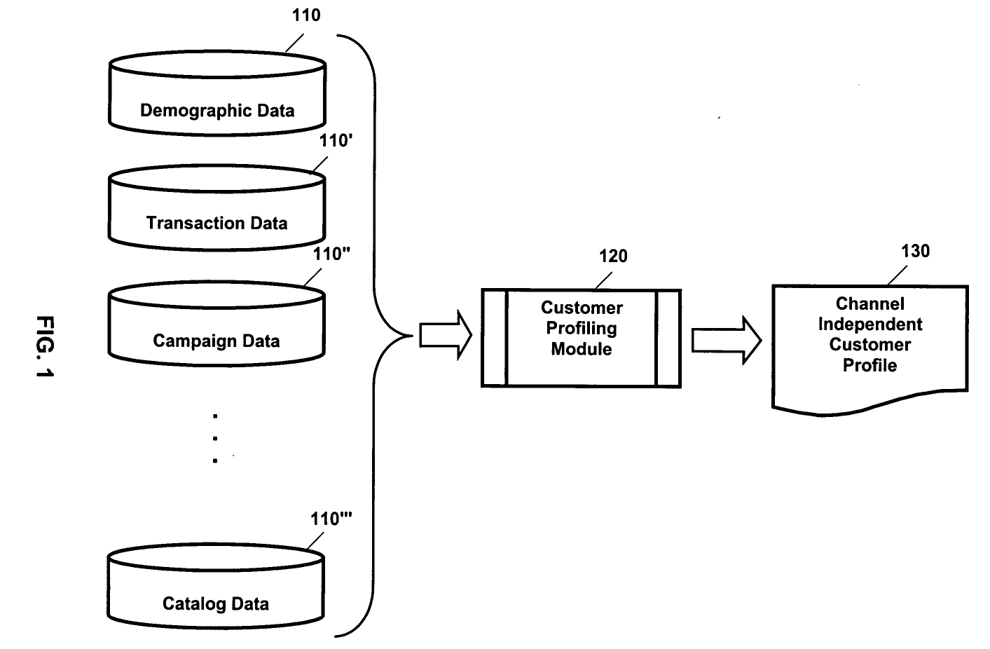

FIG. 1 schematically represents in overview the process of generating a channel-independent customer profile. First, data from various sources are consolidated. As depicted, typical data sources may comprise Demographic data 110, Transaction data 110′, Campaign data 110′, Catalog data 110′″, and any other applicable data. This data is processed by a Customer Profiling Module 120, which generates the channel-independent customer profile 130. The Customer Profiling Module 120 computes channel independent attributes of a customer from the Channel Data 110. The techniques used to compute the channel-independent attributes are described in further detail below.

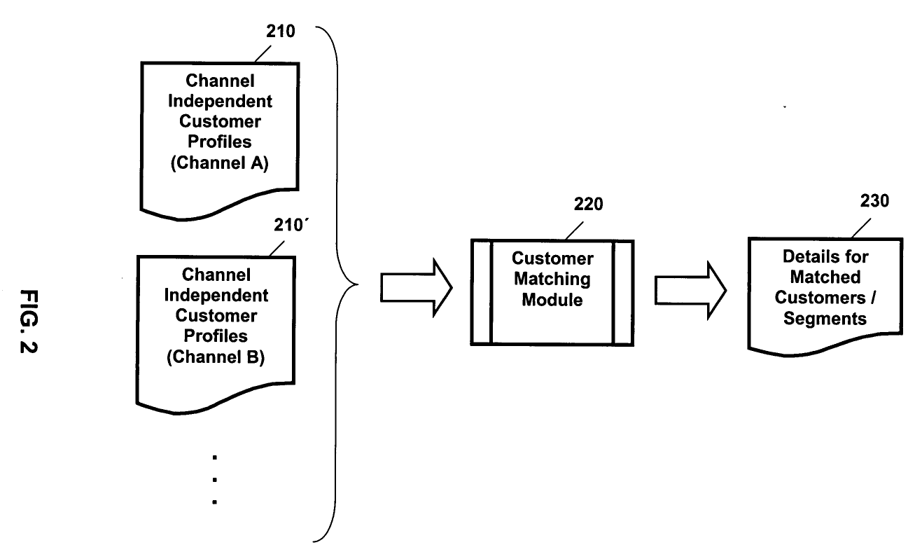

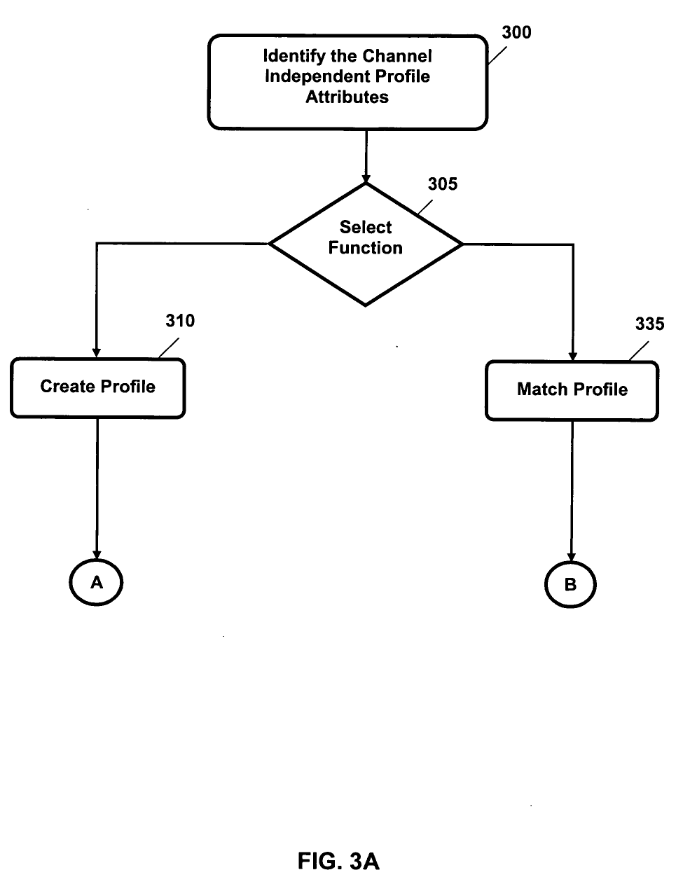

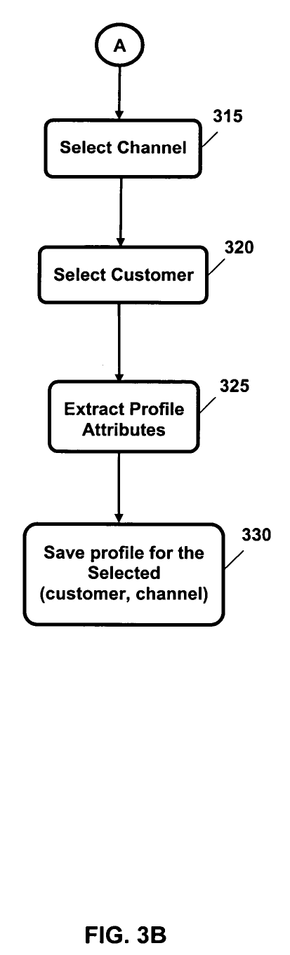

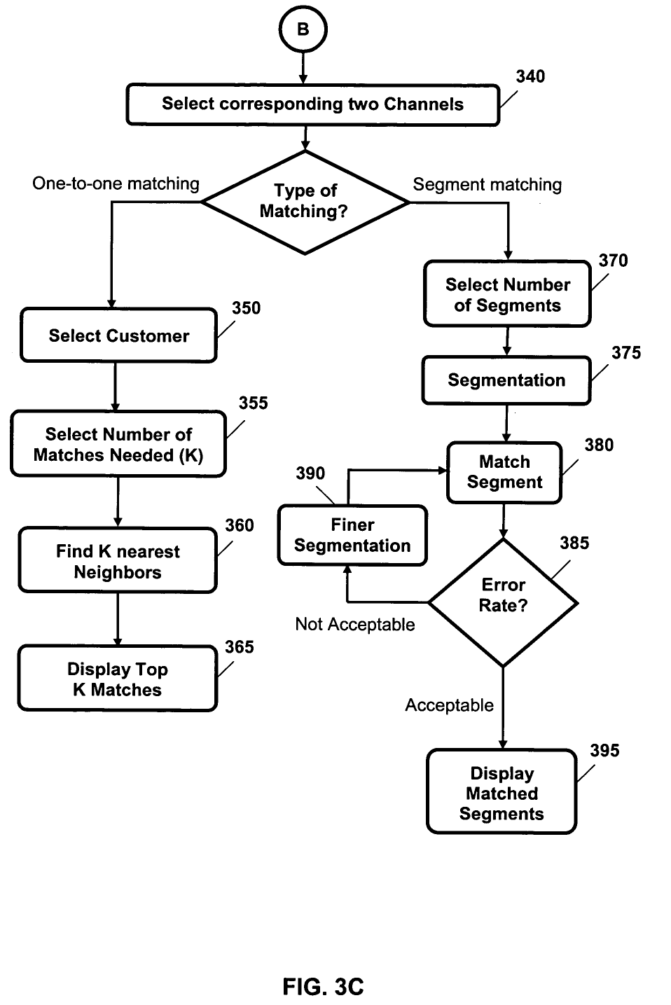

FIG. 2 schematically represents in overview the process of matching customers across selected channels, and FIGS. 3A, 3B and 3C flow chart steps involved in creating and matching customer profiles. Channel-independent customer profiles, generated as described with reference to FIG. 1, are collated from multiple channels. FIG. 2 depicts profiles 210 generated from Channel A, and profiles 210′ generated from Channel B. Profiles from other channels may also be included. A Customer Matching Module 220 collates profiles 210 from various channels, and generates details 230 of matched customers or customer segments.

Customer matching can be performed in two different ways—individually or at a segment level. For matching individual customers, profile attribute values of a customer are determined in one channel, and the top K closest matches are determined in the other channel. The value of K can be specified, as required, by the supervisor or merchant. For matching customer segments, the customer profiles are clustered, and then the individual clusters in the different channels are matched. The error rate in matching segments may depend upon the selected granularity.

This procedure is described in further detail in relation to FIGS. 3A, 3B and 3C. Channel-independent profile attributes are identified in step 300. A decision is made in step 305 concerning which function is to be selected, either to create a profile (step 310) or match a profile (step 335). To create a profile, a channel is first selected in step 315. A customer is then selected in step 320. Profile attributes, for the selected channel and customer, are extracted in step 325, as described below in further detail. The resulting customer profile is saved for the selected channel and customer in step 330. This process can be performed for all customers on all channels. A merchant or a supervisor may, however, selectively choose a few customers on certain channels, according to her own discretion, although the underlying procedure remains unchanged. This can also be done by automatically initiating the profile generation (and/or updating) procedure periodically on all or selected channels.

To match profiles, two (or possibly more) channels across which the customers to be mapped are selected in step 340. A decision is made in step 345 as to what type of matching is to be used, either one-to-one matching or customer segment matching. If one-to-one matching is selected, a customer is selected in step 350. The number of matches (K) needed for a match is selected in step 355, and the nearest K neighbors are determined in step 360. The top K matches are then displayed in step 365.

If customer segment matching is instead selected, then the number of customer segments is first selected in step 370. A process of segmentation is then performed in step 375. Segments are matched in step 380, and a decision is made in step 385 concerning whether the error rate is acceptable following segment matching in step 380. If the error rate is not acceptable, then a finer segmentation is done in step 390. Segments are matched again in step 385, and this process of iterating to successively finer segmentations may recur several times if the error rate is found to be unacceptable in step 385. Once the error rate is found to be acceptable, then the matched segments are displayed in step 395.

Once profile attribute values are calculated for all customers in all channels, the customer matching module operates to match customers or customer segment across channels. If two customers are identical, or behaviorally exactly the same, then their profile vectors are identical, or the distance between them is zero. Distance computations of this sort allow behaviorally similar customers to be identified as only channel independent attributes are analyzed.

### EXAMPLE

Consider an example implementation in which a merchant, in the customer matching process, selects a customer in one channel and makes a possible query about the similar customers in some other channel. Table 1 below lists the steps that are performed.

TABLE 1

| | |
|---|---|
| 1. | Compute profile attribute values for all customers |
| 2. | Select a customer (for example, customer 1) in one channel (for example, |
| | channel A). |
| 3. | Create a profile vector for selected customer 1. (The Profile Vector is composed of |
| | only the attribute values. The Profile Vector depends on the sequence of the |
| | profile attributes and this sequence is predefined according to the database table.) |
| 4. | Select another channel (for example, channel B) in which a match is to be found. |
| 5. | Select value of K (the number of matches to be found). |
| 6. | Create profile vectors for all customers in channel B. |
| 7. | Compute the distances of the profile vector of customer 1 in channel A from the |
| | profile vectors of all customers in channel B. |
| 8. | Sort the distance list in ascending order. |
| 9. | Top K matches in the sorted list identify the top K customers in channel B |
| | behaviorally closest to customer 1 in channel A. |
| 10. | This process can also be extended to customer segments for comparing different |
| | customer segments in different channels, as described above. |

Profile attributes

Profile attributes are typically selected as variables that are considered significant from a marketing or retailing viewpoint. Particular profile attributes may equate with qualitative categorizations such as price conscious, big spender, impulsive buyer, and so on.

Table 2 below presents representative attributes that may be included in a customer profile. Each of these examples is considered in turn below.

TABLE 2

[1] BrandLoyaltyToProductSegment
[2] Brand Loyalty
[3] PricePreferenceToProductSegment
[4] PreferenceTowardsLowerPricedItems
[5] PreferenceTowardsHigherPricedItems
[6] ResponsivenessToMarketingInitiative
[7] ResponsivenessToHighValueOffers

Other profile attributes may also be used. Mathematic expressions for calculating the representative profile attributes of Table 2 are presented below. Profile attributes can be computed in many other different ways. As an example, rules stored in a rule engine may be used for determining the value of particular profile attributes. A rules engine contains rules that are either explicitly defined by the merchant, or obtained through use of collaborative filtering, association rule mining, and other techniques.

[1] BrandLoyaltyToProductSegment

LoyaltyToProductSegment(custId, productSegmentld)=Lᵢ(p);

CustId is represented by i and the productSegmentId is represented by p.
Lᵢⱼ(p)=Loyalty of customer i to brand j in product segment p

$${L}_{ij} ( p ) = \frac{{X}_{ij} ( p )}{{\sum }_{j} {X}_{ij} ( p )}$$
Xᵢⱼ(p)=Amount purchased by customer i to brand j in product segment p
Lᵢ(p)=Loyalty of customer i to some brand in product segment p
Lᵢ(p)=maxⱼ{Lᵢⱼ(p)}
   [2] Loyalty

Loyalty(custId) =Liᵢ.
Lᵢ =Loyalty of customer i in general towards products

$${L}_{i} = \frac{{\sum }_{p} {L}_{i} ( p )}{M}$$
M =number of products
   [3] PricePreferenceToProductSegment

PricePreferenceToProductSegment(custId, productSegmentId)=Pᵢ(p);

Here custId is represented by i and the productSegmentId is represented by p.

xᵢ(p)=Price paid by customer i over product segment p
Vₘᵢₙ(p)=Minimum price in the same product segment p
Vₘₐₓ(p)=Maximum price in the same product segment p
Pᵢ(p)=Price preference of customer i over product segment p

$${P}_{i} ( p ) = \frac{{x}_{i} ( p ) - {V}_{min} ( p )}{{V}_{max} ( p ) - {V}_{min} ( p )}$$

[4] PreferenceTowardsLowerPricedItems

PreferenceTowardsLowerPricedItems(custId)=S_{1 (P}ᵢ)

Where S₁ is an S-function in [0, 1], and

$${P}_{i} = \frac{{\sum }_{p} {P}_{i} ( p )}{M}$$

M=Number of products

[5] PreferenceTowardsHigherPricedItems

PreferenceTowardsHigherPricedItems(custId)=1−S₂ (Pᵢ)

Where S₂ is an S-function in [0, 1], and

$${P}_{i} = \frac{{\sum }_{p} {P}_{i} ( p )}{M}$$

M=Number of products
[6] ResponsivenessToMarketingInitiative

$$ResponsivenessToMarketingInitiative ( custId ) = S ( \frac{{k}_{i}}{{K}_{i}} )$$

Where Kᵢ=Total number of coupons offered to the customeri,
kᵢ=Number of coupons redeemed by customeri, and
S is an S-function in [0, 1].
[7]ResponsivenessToHighValueOffers

$$ResponsivenessToHighValueOffers ( custId ) = S ( \frac{{v}_{i}}{{V}_{i}} )$$
Where Vᵢ=Total offered discount (absolute value) to customeri,
vᵢ=Total amount of discount redemption by customeri, and
S is an S-function in [0, 1].
   Matching customer profiles

A customer profile, once established, can be incrementally updated based on the customer's observed behavior over time. The profile attributes presented in Table 2 above depend on the customer's behavior, and are independent of the channel, in the sense that such profile attributes do not specifically relate to a particular channel. For example, if a customer is loyal to some particular brand in a product segment (suggesting an underlying affinity of some kind with that brand), then she may be assumed to be loyal to that brand in other channels, within a certain duration (for example, a year).

Matching customer profiles can be performed with various distance measures, such as Euclidian distance, city-block distance, cosine similarity, or simple percentage of match count. Instead of computing the distance between individual customers in different channels, the distance between customer segments in different channels can also be determined, given suitable customer segment definitions.

A profile attribute can be taken to be channel independent if the techniques used for computing the value of the profile attribute do not depend on the channel characteristics. Such profile attributes of a customer profile are described as “channel-independent”, as these profile attributes do not alter much across channels. Conceptually, the customer does not consciously change her behavior across channels in respect of channel-independent profile attributes. For example, if a customer is loyal to a brand, then she remains loyal across channels. On the other hand, a customer may visit a particular channel frequently, and another channel seldom. Frequency of visit to a particular channel is, for example, not a channel-independent profile attribute.

Distance computations can find the behaviorally similar customers because we always consider only the channel independent attributes. If two customers are identical or behaviorally exactly same then their profile vectors are identical or, conversely, the distance between their profile vectors is zero. The distance computation between two profiles from two different channels can be performed for profile vectors that consist of profile attributes that are channel-independent. If the profile attributes (composing the profile) differ across channels or are dependent of channel characteristics, then distance computation looses meaning.

For example, consider profile attribute “time spent in channel”. Normally, a user spends relatively little time on a mobile phone (WAP) channel, compared with a retail store channel. This difference may be attributed to the fact that the former is expensive, and not particularly “user-friendly”. Thus attribute “time spent in channel” does not have similar values for different channels. Another example is “frequency of visit”, which again has different characteristics on different channels. A customer normally visits web channels for gathering information and researching product much more and then buys at store channel after having a feel. So “frequency of visit” on these two channels is not comparable.

Again, a customer in one channel can be matched with more than one in some other channel, thus one obtains a list of top K matching customers in other channel. The matching process can be restricted by using additional information. For example, the same person cannot be simultaneously logged on two channels. Heuristic observations can be used to increase the accuracy of the matching process.

Computer hardware

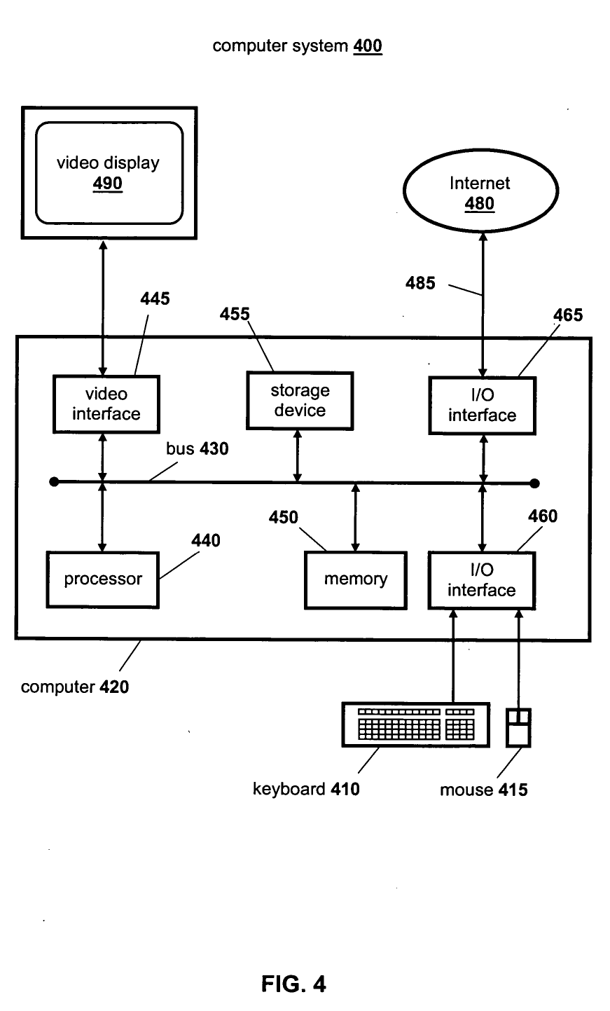

FIG. 4 is a schematic representation of a computer system 400 suitable for executing computer software programs for implementing the techniques described herein for cross-channel customer matching. Computer software programs executes under a suitable operating system installed on the computer system 400, and may be thought of as a collection of software instructions for implementing particular steps.

The components of the computer system 400 include a computer 420, a keyboard 410 and mouse 415, and a video display 490. The computer 420 includes a processor 440, a memory 450, input/output (I/O) interfaces 460, 465, a video interface 445, and a storage device 455. All of these components are operatively coupled by a system bus 430 to allow particular components of the computer 420 to communicate with each other via the system bus 430.

The processor 440 is a central processing unit (CPU) that executes the operating system and the computer software program executing under the operating system. The memory 450 includes random access memory (RAM) and read-only memory (ROM), and is used under direction of the processor 440.

The video interface 445 is connected to video display 490 and provides video signals for display on the video display 490. User input to operate the computer 420 is provided from the keyboard 410 and mouse 415. The storage device 455 can include a disk drive or any other suitable storage medium.

The computer system 400 can be connected to one or more other similar computers via a input/output (I/O) interface 465 using a communication channel 485 to a network, represented as the Internet 480.

The computer software program may be recorded on a storage medium, such as the storage device 455. Alternatively, the computer software can be accessed directly from the Internet 480 by the computer 420. In either case, a user can interact with the computer system 400 using the keyboard 410 and mouse 415 to operate the computer software program executing on the computer 420. During operation, the software instructions of the computer software program are loaded to the memory 450 for execution by the processor 440.

Other configurations or types of computer systems can be equally well used to execute computer software that assists in implementing the techniques described herein.

Example Data Structures and Procedures

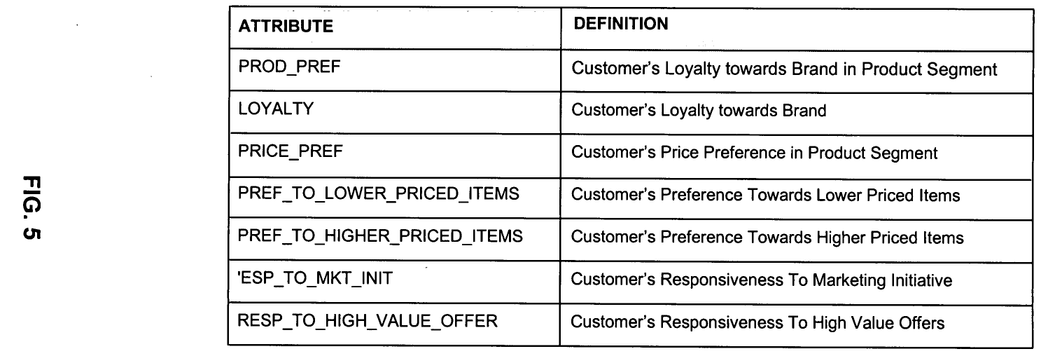

FIG. 5 tabulates example attributes for a sample customer profile, with associated definitions. These profile attributes directly correspond with those of Table 2 above. These form a limited number of examples, as other attributes are likely to be of interest in many cases. A core set of customer attributes may be standardized upon for general use, or a supplementary set of attributes may be defined for use in particular circumstances.

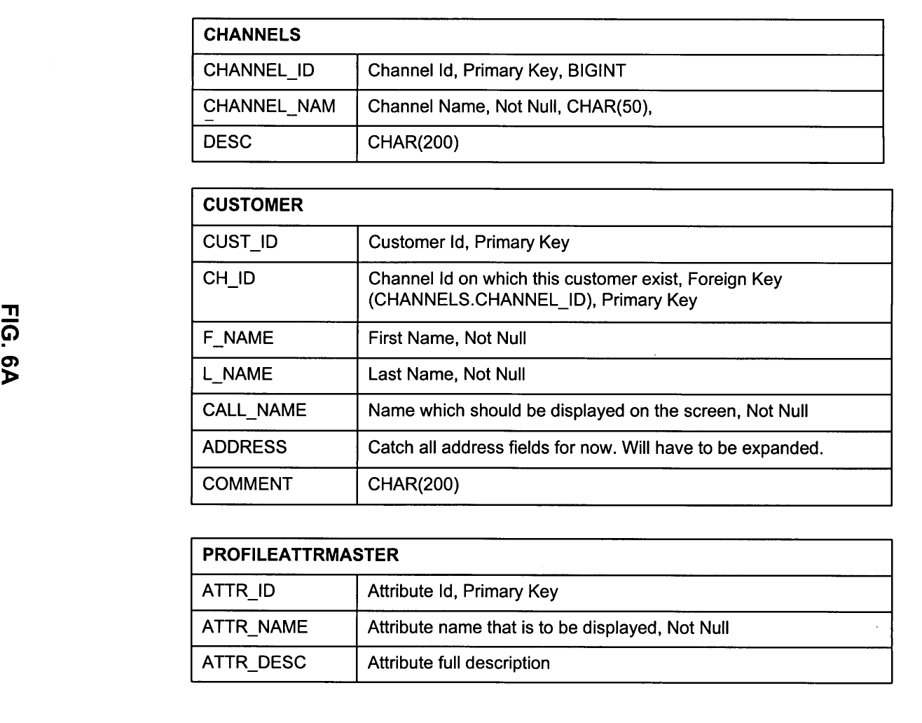

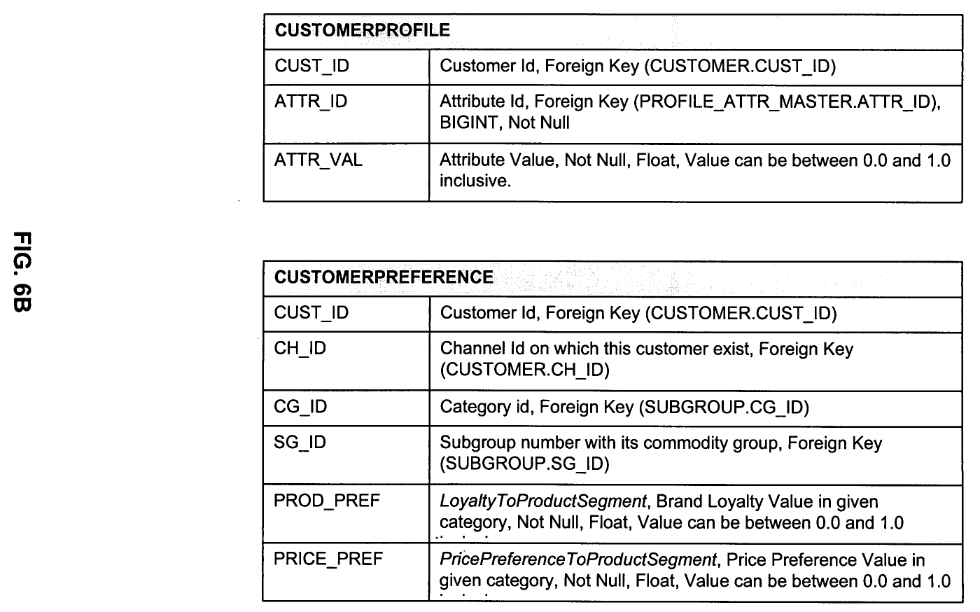

FIGS. 6A and 6B tabulate example data structures that may be used in storing customer profile information. These tables are conveniently stored as tables in a database application. Some tables share particular fields, such as CUST_ID, which identifies particular customers, and CH_ID, which identifies particular channels. These are database tables created to store the customer profiles on all channels. A customer is identified by CUST_ID and CH_ID.

The CHANNELS table in FIG. 6A indexes all relevant channels, by recording an index, a name, and a description, as depicted. The CUSTOMER table stores customer identification details, though not profile information.

Customer profile information can be stored across two tables, namely the CUSTOMERPREFERENCE and CUSTOMERPROFILE tables, as presented in FIG. 6B. The CUSTOMERPREFERENCE table contains brand preference and price preference information for particular product segments, in the fields PROD_PREF and PRICE_PREF. These profile attributes correspond with profile attributes [1] and [3] presented in Table 2 above, and are selected from FIG. 5 as being specific to certain product categories. The number of the product categories for which this information can be recorded may be as many as the number of product segments on one channel.

The profile attributes PRODPREF and PRICE _PREF are intentionally stored in a table CUSTOMERPREFERENCE, which is separate from CUSTOMERPROFILE. The reason for this is that these two profile attributes (PROD_PREF and PRICE_PREF) of the CUSTOMERPREFERENCE table have multiple values for each customer, one each corresponding to a product segment (a combination of CG_ID, identifying the product category, and SG_ID, identifying the product segment within a product category). All the other profile attributes presented in FIG. 5 have a single value for each customer and are stored in another table, CUSTOMERPROFILE.

The CUSTOMERPROFILE table contains all other profile attributes, which have only single value for each attribute, for a customer on one channel. In other words, these profile attributes do not relate to different product categories, such as the remaining profile attributes presented in FIG. 5.

The CUSTOMERPROFILE and CUSTOMERPREFERNCE tables are used in combination, as described above, to store the customer profile. A customer profile can be generated by selecting a customer and a channel. The customer profile can be generated mathematically, as described above, for different profile attributes, and then stored in CUSTOMERPROFILE and CUSTOMERPREFERNCE tables. A customer profile that already exists can be updated as required.

The value of each profile attribute may be computed using catalog data, transaction data, campaign data, and any other relevant source of information. Table 3 below presents a pseudocode algorithm for computing a value for the profile attribute PROD_PREF (Brand loyalty within a Product Segment). In the pseudocode algorithm of Table 3 below, the variable “sum” represents a running sum of the amount of all purchases of all products within a product category, while the term “X” represents an amount of the purchase of all products of a brand within a product category. The term “Xmax” represents a running maximum of the total amount of all purchases of all products of a brand within a product category.

TABLE 3

| | |
|---|---|
| 001 | Select channel CH_ID |
| 002 | Select customer CUST_ID |
| 003 | For selected (customer CUST_ID, CH_ID) { |
| 004 | Get all categories |
| 005 | For every (product category CG_ID, SG_ID) { |
| 006 | sum = 0 |
| 007 | Xmax = −infinite |
| 008 | For every (BRAND_ID) { |
| 009 | Get X from transaction table using the key (CUST_ID, |
| | CH_ID, CG_ID, SG_ID, BRAND_ID)* |
| 010 | sum = sum + X |
| 011 | Xmax = max (Xmax, X) |
| 012 | } |
| 013 | If (sum is not equal to ZERO) { |
| 014 | PROD_PREF = Xmax / sum |
| 015 | Save value of PROD_PREF to database |
| | with the key |
| | (CUST_ID, CH_ID, CG_ID, SG_ID) in |
| | CUSTOMERPREFERENCE |
| 016 | } |
| 017 | } |
| 018 | } |

Values for other attributes can also be similarly computed. Once values for all profile attributes are computed, these values are saved in the CUSTOMERPROFILE and CUSTOMERPREFERNCE tables for future reference.

Table 4 below presents an example query for the query procedure referenced in line 009 of the pseudocode algorithm of FIG. 7. This query fetches a value of X for CUST_ID=14952342,CH_ID=−1, BRAND_ID=2, CG_ID=50, SG_ID=23.

TABLE 4
SELECT
SUM(TRANSACTIONDETAILS.AMOUNT_SPENT) AMOUNT
FROM
ADMINISTRATOR.TRANSACTIONDETAILS AS
TRANSACTIONDETAILS,
ADMINISTRATOR.TRANSACTION AS TRANSACTION,
ADMINISTRATOR.PRODUCT AS PRODUCT
WHERE
TRANSACTIONDETAILS.TRANS_ID =
TRANSACTION.TRANS_ID AND
TRANSACTIONDETAILS.ITEM_ID = PRODUCT.ITEM_ID AND
TRANSACTION.CUST_ID = 14952342 AND
TRANSACTION.CH_ID = −1 AND
PRODUCT.BRAND_ID = 2 AND
PRODUCT.CG_ID = 50 AND
PRODUCT.SG_ID = 23

Table 5 below presents pseudocode for determining the top K matching customer profiles using distance computation.

TABLE 5

| | |
|---|---|
| 001 | Select K |
| 002 | A = Select channel CH_ID |
| 003 | B = Select customer CUST_ID |
| 004 | CP1 = Read customer profile from CUSTOMERPREFERENCE |
| | and CUSTOMERPROFILE table using the key (B, A) |
| 005 | V1 = POPULATE_PROFILE_VECTOR (CP1) |
| 006 | D = Select channel for finding a match CH_ID |
| 007 | Initialize DIST_LIST = null |
| 008 | For every (customer CUST_ID (E), D) { |
| 009 | CP2 = Read customer profile from CUSTOMERPREFERENCE |
| | and CUSTOMERPROFILE table using the key (E, D) |
| 010 | V2 = POPULATE_PROFILE_VECTOR (CP2) |
| 011 | DIST = COMPUTE_DISTANCE (V1, V2) |
| 012 | APPEND (DIST_LIST, (B, DIST)) |
| 013 | } |
| 014 | OUTPUT_DIST_LIST = SORT_ASCENIDNG (DIST_LIST) |
| 015 | DISPLAY OUTPUT_DIST_LIST (1,..,K) |

Conclusion

The techniques described herein relate to commerce, and more specifically to retailing, in the context of “finding”on another sales channel a customer whose identity is known on one channel. The described techniques find application, however, beyond the retail industry.

As an example, customers may be identified, in the context of a commercial merger, from the separate customer details independently maintained by the two merged companies. Further, the described techniques can be used by banks or other financial institutes for fraud prevention by identifying a customer segment whose profile matches that of a representative fraudulent customer. A yet further example involves streamlining an organization's supply chain, by identifying components whose behavior or usage profile matches that of each other, or that of a standard component. Thus, related products can be identified for possible replacement with a single standardized component to streamline an organization's supply chain.

Other applications are also possible. Various alterations and modifications can be made to the techniques and arrangements described herein, as would be apparent to one skilled in the relevant art.

1. A method for conducting cross-channel customer identification, said method comprising:
accessing, for a selected customer and a selected channel, a customer profile that records values for a plurality of customer profile attributes that are independent of the selected channel;
comparing the accessed customer profile with a plurality of corresponding customer profiles for one or more channels other than the selected channel; and
identifying one or more compared customer profiles as a likely match for the computed customer profile.

2. The method as claimed in claim 1, further comprising storing customer profile information based upon observed transactional activity behavior of a customer.

3. The method as claimed in claim 2, further comprising computing values for customer profile attributes based upon the stored customer profile information.

4. The method as claimed in claim 1, further comprising identifying a plurality of the compared customer profiles as individually ranked matches for the selected customer.

5. The method as claimed in claim 1, further comprising the identifying a plurality of the compared customer profiles as representative of a customer segment.

6. The method as claimed in claim 1, wherein said customer profile attributes comprise any of loyalty to product segment, loyalty, price preference to product segment, preference towards lower priced items, preference towards higher priced items, responsiveness to marketing initiative, and responsiveness to high value offers.

7. A computer program product comprising:
a storage device readable by a computer system and recording software instructions executable by the computer system for cross-channel customer matching, the software instructions implementing a method comprising:
accessing, for a selected customer and a selected channel, a customer profile that records values for a plurality of customer profile attributes that are independent of the selected channel;
comparing the accessed customer profile with a plurality of corresponding customer profiles for one or more channels other than the selected channel; and
identifying one or more compared customer profiles as a likely match for the computed customer profile.

8. A computer system comprising:
a processor for executing software instructions;
a memory for storing software instructions;
a system bus coupling the memory and the processor; and
a storage medium recording software instructions that are loadable to the memory for performing cross-channel customer matching and implementing a method comprising:
accessing, for a selected customer and a selected channel, a customer profile that records values for a plurality of customer profile attributes that are independent of the selected channel;
comparing the accessed customer profile with a plurality of corresponding customer profiles for one or more channels other than the selected channel; and
identifying one or more compared customer profiles as a likely match for the computed customer profile.

9. The computer program product as claimed in claim 7, wherein said method further comprises storing customer profile information based upon observed transactional activity behavior of a customer.

10. The computer program product as claimed in claim 9, wherein said method further comprises computing values for customer profile attributes based upon the stored customer profile information.

11. The computer program product as claimed in claim 7, wherein said method further comprises identifying a plurality of the compared customer profiles as individually ranked matches for the selected customer.

12. The computer program product as claimed in claim 7, wherein said method further comprises identifying a plurality of the compared customer profiles as representative of a customer segment.

13. The computer program product as claimed in claim 7, wherein said customer profile attributes comprise any of loyalty to product segment, loyalty, price preference to product segment, preference towards lower priced items, preference towards higher priced items, responsiveness to marketing initiative, and responsiveness to high value offers.

14. The computer system as claimed in claim 8, wherein said method further comprises storing customer profile information based upon observed transactional activity behavior of a customer.

15. The computer system as claimed in claim 14, wherein said method further comprises computing values for customer profile attributes based upon the stored customer profile information.

16. The computer system as claimed in claim 8, wherein said method further comprises identifying a plurality of the compared customer profiles as individually ranked matches for the selected customer.

17. The computer system as claimed in claim 8, wherein said method further comprises identifying a plurality of the compared customer profiles as representative of a customer segment.

18. The computer system as claimed in claim 8, wherein said customer profile attributes comprise any of loyalty to product segment, loyalty, price preference to product segment, preference towards lower priced items, preference towards higher priced items, responsiveness to marketing initiative, and responsiveness to high value offers.
